(19) United States
(12) Patent Application Publication
(10) Pub. No.: US 2026/0024963 A1
(43) Pub. Date: Jan. 22, 2026

(54) HELMET SHROUD POWER DISTRIBUTION HUB

(71) Applicant: Division Group, LLC, Broussard, LA (US)

(72) Inventors: Trent Zimmer, Youngsville, LA (US); Benjamin Mahan, Martinsville, IN (US)

(73) Assignee: Division Group, LLC, Broussard, LA (US)

(21) Appl. No.: 19/275,637

(22) Filed: Jul. 21, 2025

Related U.S. Application Data
(60) Provisional application No. 63/673,821, filed on Jul. 22, 2024.

(51) Int. Cl. H02B 1/26; A42B 3/04; F21V 33/00; H02J 1/00

(52) U.S. Cl. CPC H02B 1/26; A42B 3/0453; F21V 33/0004; H02J 1/00

(57) ABSTRACT

A power distribution hub is disclosed. The power distribution hub includes a housing having a concave back surface configured for attachment to a helmet and a mating interface configured for attachment of a shroud. An onboard power source is contained within the housing. A conductive interface is disposed on the mating interface and electrically connected to the onboard power source. The conductive interface is configured to supply power to a connected peripheral electronic device.

### CROSS-REFERENCE TO RELATED APPLICATION(S)

This application claims the benefit of U.S. Provisional Application Ser. No. 63/673,821, filed on Jul. 22, 2024, the entirety of which is incorporated herein by reference.

### TECHNICAL FIELD

This disclosure relates to implementations of a power distribution hub configured for use with a helmet shroud.

### BACKGROUND

Commercial and professional users often wear helmets equipped with peripheral electronic devices, such as night-vision goggles, cameras, illumination systems, and communication equipment, to enhance operational effectiveness. These peripheral electronic devices typically include dedicated onboard power sources and mounting hardware and, in some cases, rely on external power sources and power cables.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed are implementations of a power distribution hub configured for use with a helmet shroud and to supply power to at least one connected peripheral electronic device.

In one example implementation, a power distribution hub comprises a housing including a concave back surface configured for attachment to a helmet and a mating interface configured for attachment of a shroud; an onboard power source contained within the housing; and a conductive interface disposed on the mating interface, electrically connected to the onboard power source, and configured to supply power to a connected peripheral electronic device.

In another example implementation, a power distribution hub comprises a housing including a concave back surface configured for attachment to a helmet and a convex mating interface configured for attachment of a shroud; an onboard power source contained within the housing; and a conductive interface disposed on the mating interface, electrically connected to the onboard power source, and configured to supply power to a peripheral electronic device attached to the shroud.

In yet another example implementation, a power distribution hub comprises a housing including a receptacle for a power source, a concave back surface configured for attachment to a helmet, and a shroud mating interface. The shroud mating interface comprises a conductive interface that is in electrical communication with the receptacle and is configured to supply power to a connected peripheral electronic device.

Any of the implementations herein, wherein the conductive interface comprises an array of electrical contacts.

Any of the implementations herein, wherein each electrical contact extends through a corresponding opening in the mating interface of the housing.

Any of the implementations herein, wherein the array of electrical contacts is configured to electrically connect with corresponding contacts on an accessory mount attached to the shroud.

Any of the implementations herein, further comprising at least one USB port disposed along a peripheral edge of the housing, which is electrically connected to the onboard power source.

Any of the implementations herein, further comprising a power control switch electrically coupled to the onboard power source and configured to selectively route power between the onboard power source, the conductive interface, and the at least one USB port.

Any of the implementations herein, further comprising a camera system mounted within the housing and electrically connected to the onboard power source.

Any of the implementations herein, further comprising a lighting system including at least one LED mounted within the housing and electrically connected to the onboard power source.

Any of the implementations herein, further comprising a visual status system including at least one LED mounted on a portion of the housing positioned to be visible to a wearer of the helmet.

Any of the implementations herein, wherein the mating interface includes an opening at each of its three corners.

Any of the implementations herein, wherein the conductive interface comprises an array of electrically conductive pins.

Any of the implementations herein, wherein each electrically conductive pin extends through a corresponding opening in the mating interface of the housing.

Any of the implementations herein, wherein the array of electrically conductive pins is configured to electrically connect with corresponding contacts on an accessory mount attached to the shroud.

Any aspect of any implementation, in combination with any one or more aspects of any other implementation(s).

Any one or more of the features disclosed herein.

Any one or more of the features as substantially disclosed herein.

Any one or more of the features as substantially disclosed herein, in combination with any one or more other features as substantially disclosed herein.

Any one of the aspects, features, or implementations, in combination with any one or more other aspects, features, or implementations.

Use of any one or more of the aspects or features disclosed herein.

It should be appreciated that any feature described herein can be claimed in combination with any other feature(s) described herein, regardless of whether the features originate from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided below.

Additional features and advantages are described herein and will be apparent from the following description and figures.

### BRIEF DESCRIPTION OF THE DRAWINGS

FIG. 1 is a perspective view of a power distribution hub according to the principles of the present disclosure.

FIG. 2 is another perspective view of the power distribution hub shown in FIG. 1.

FIG. 3 is a front elevational view of the power distribution hub shown in FIG. 1.

FIG. 4 is a rear elevational view of the power distribution hub shown in FIG. 1.

FIG. 5 is a left side elevational view of the power distribution hub shown in FIG. 1.

FIG. 6 is a right side elevational view of the power distribution hub shown in FIG. 1.

FIG. 7 is a bottom plan view of the power distribution hub shown in FIG. 1.

FIG. 8 is a top plan view of the power distribution hub shown in FIG. 1.

FIG. 9 is a perspective view of a shroud overlaying the power distribution hub shown in FIG. 1.

FIG. 10 is another perspective view of the shroud and power distribution hub assembly shown in FIG. 9.

FIG. 11 is a perspective view of the shroud and power distribution hub assembly shown in FIG. 9, attached to a helmet. Two compatible plugs are shown as being inserted into separate USB ports.

FIG. 12 is a front elevational view of the shroud and power distribution hub assembly shown in FIG. 9, attached to the helmet.

FIG. 13 is a top plan view of the shroud and power distribution hub assembly attached to the helmet, as shown in FIG. 11.

FIG. 14 is another perspective view of the shroud and power distribution hub assembly attached to the helmet, as shown in FIG. 11.

FIG. 15 is a right side elevational view of the shroud and power distribution hub assembly attached to the helmet, as shown in FIG. 11.

FIG. 16 is a left side elevational view of the shroud and power distribution hub assembly attached to the helmet, as shown in FIG. 11.

FIG. 17 is a block diagram illustrating various components of the power distribution hub shown in FIG. 1, including additional components described in this disclosure that are not otherwise illustrated.

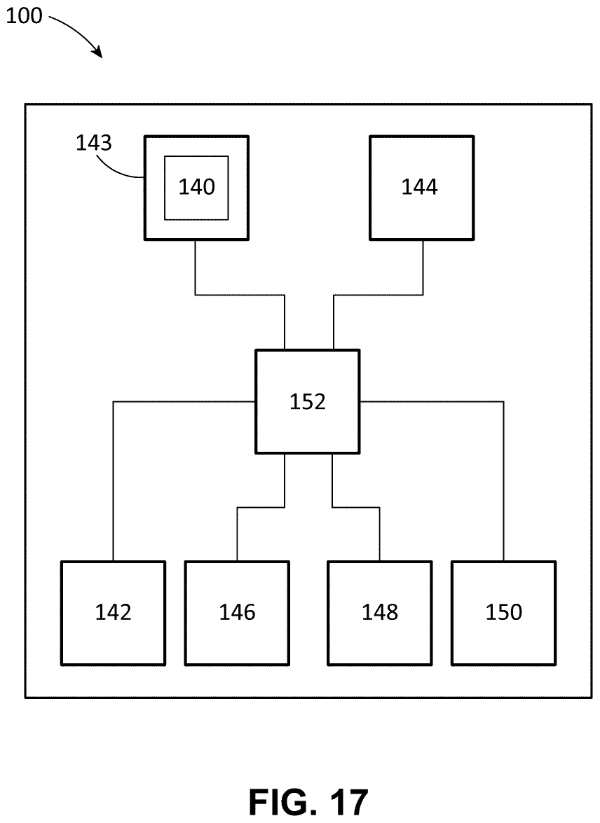

Like reference numerals refer to corresponding parts throughout the several views of the drawings.

### DETAILED DESCRIPTION

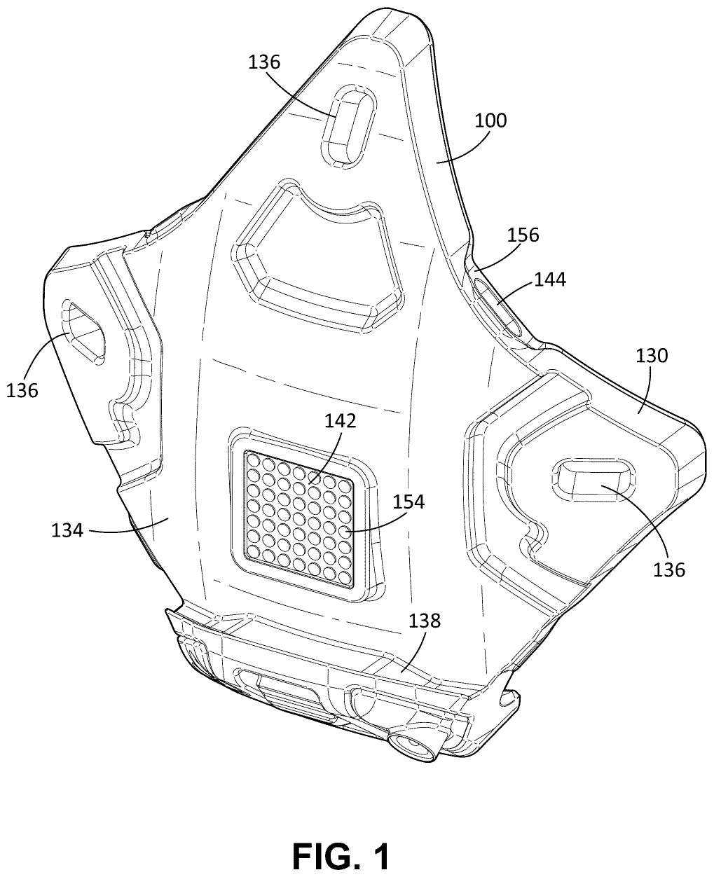

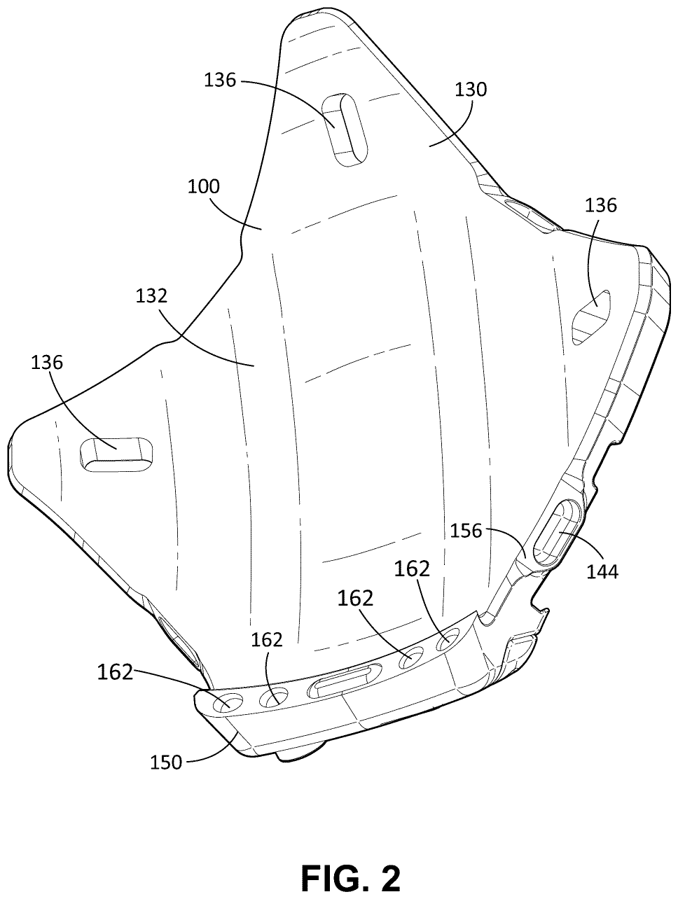

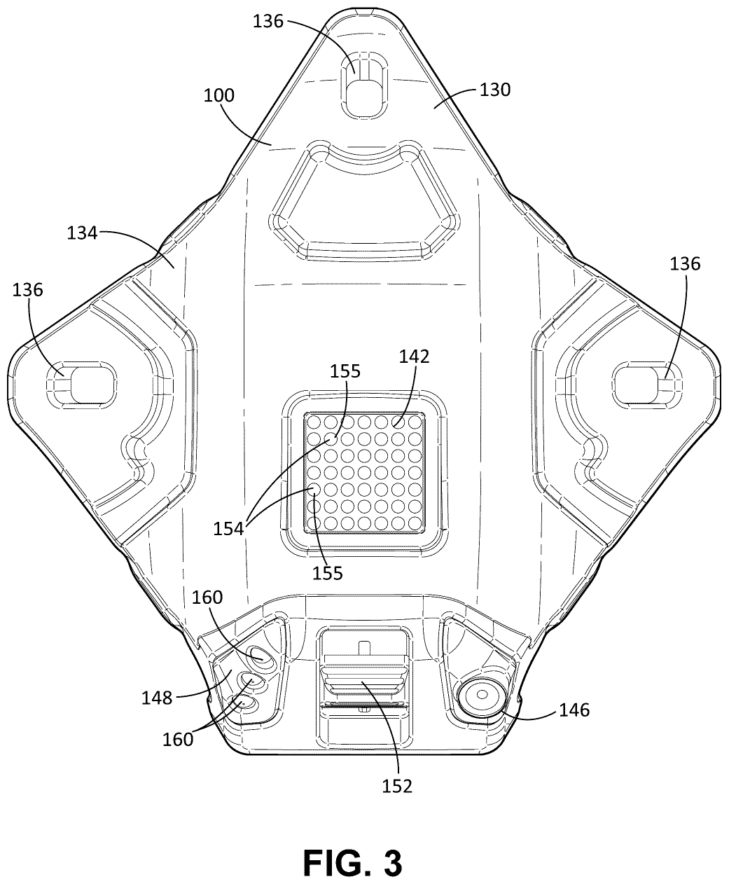

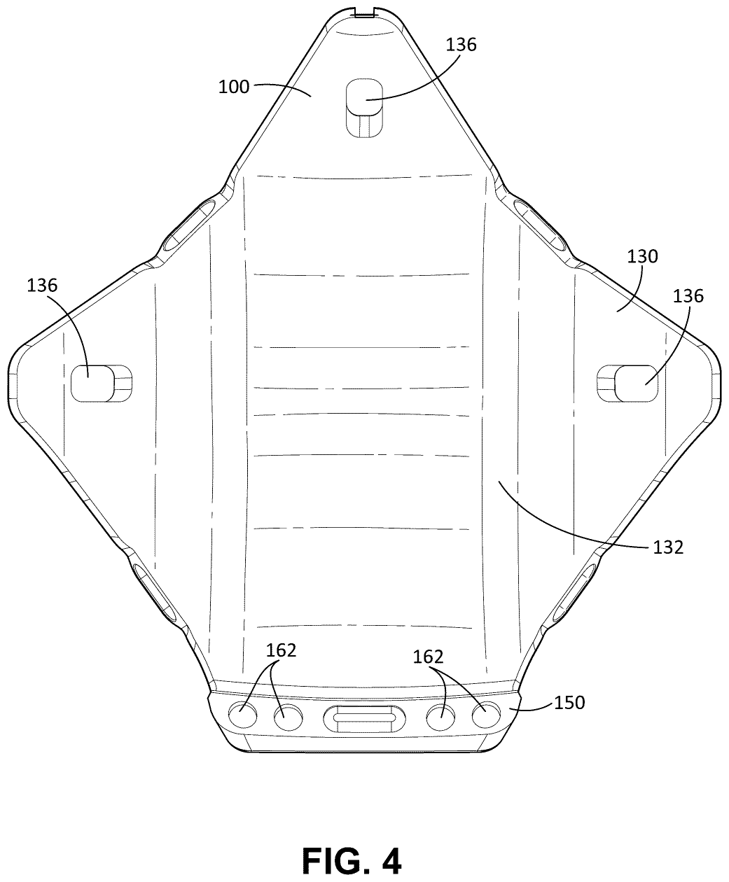

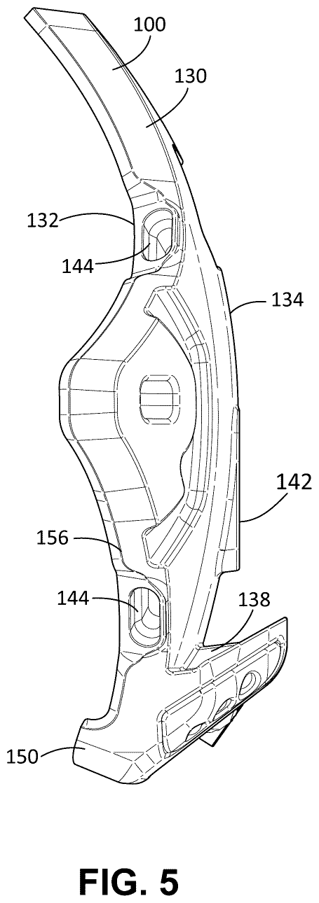

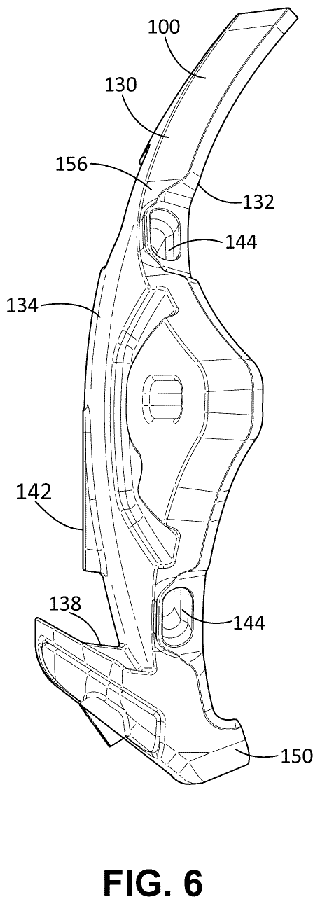

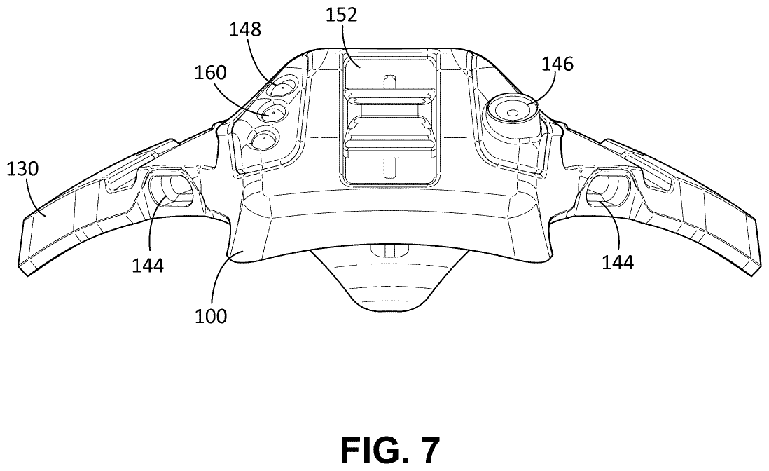

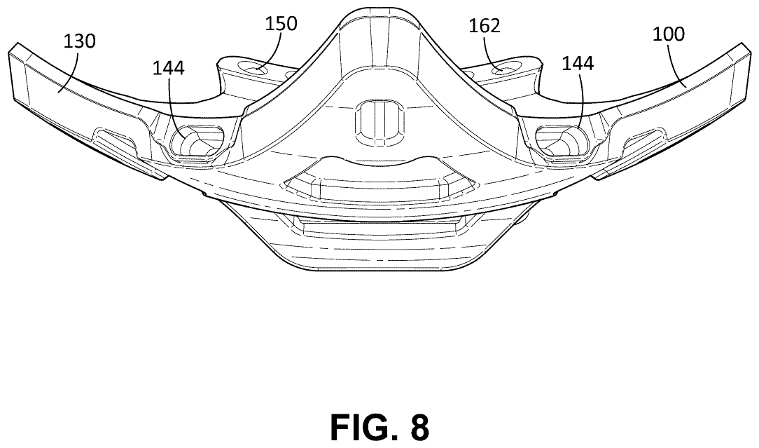

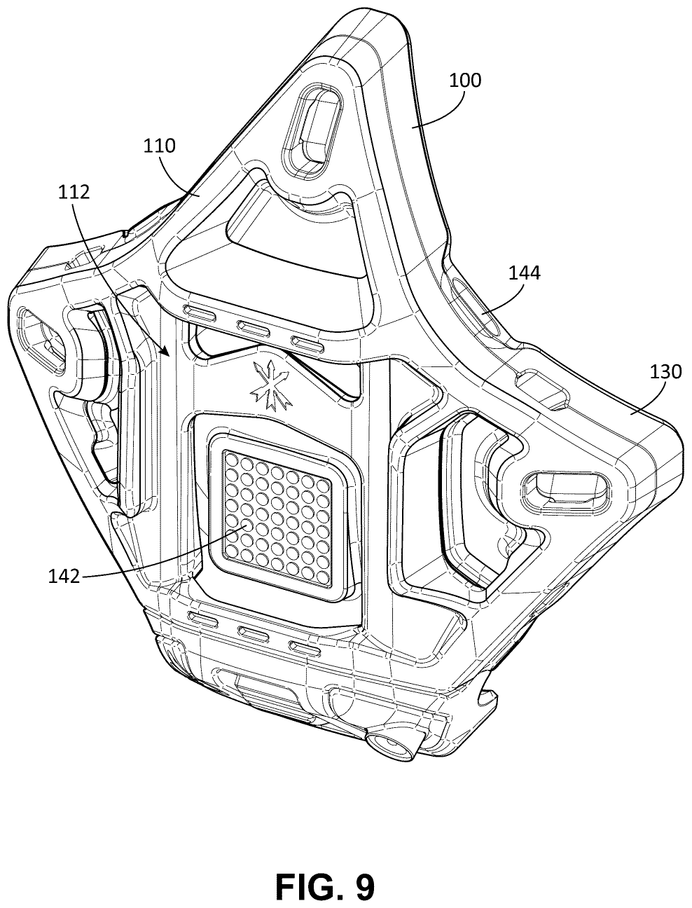

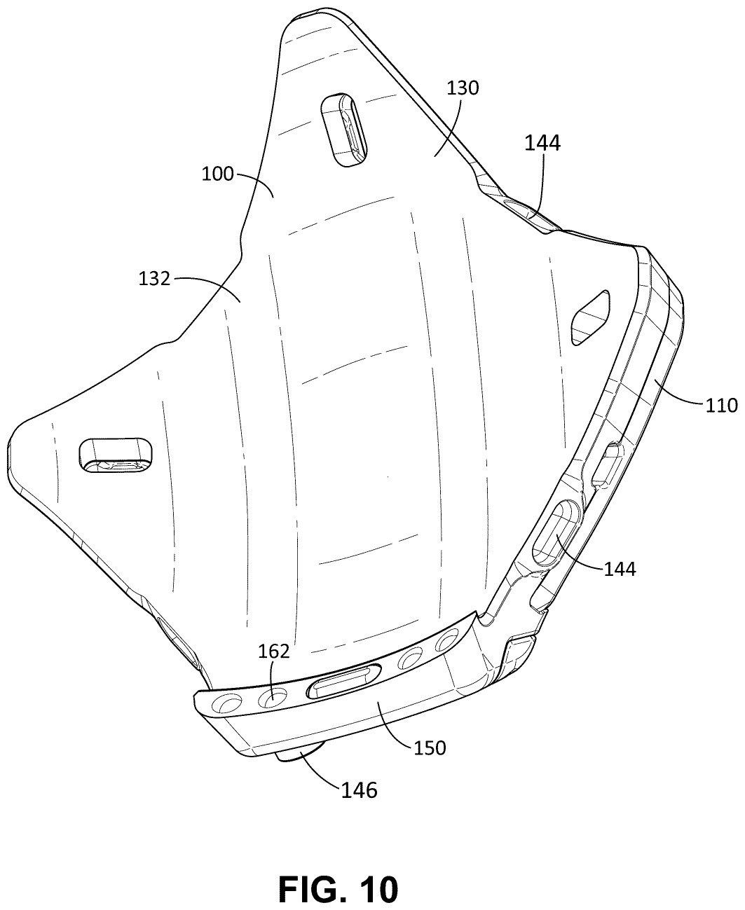

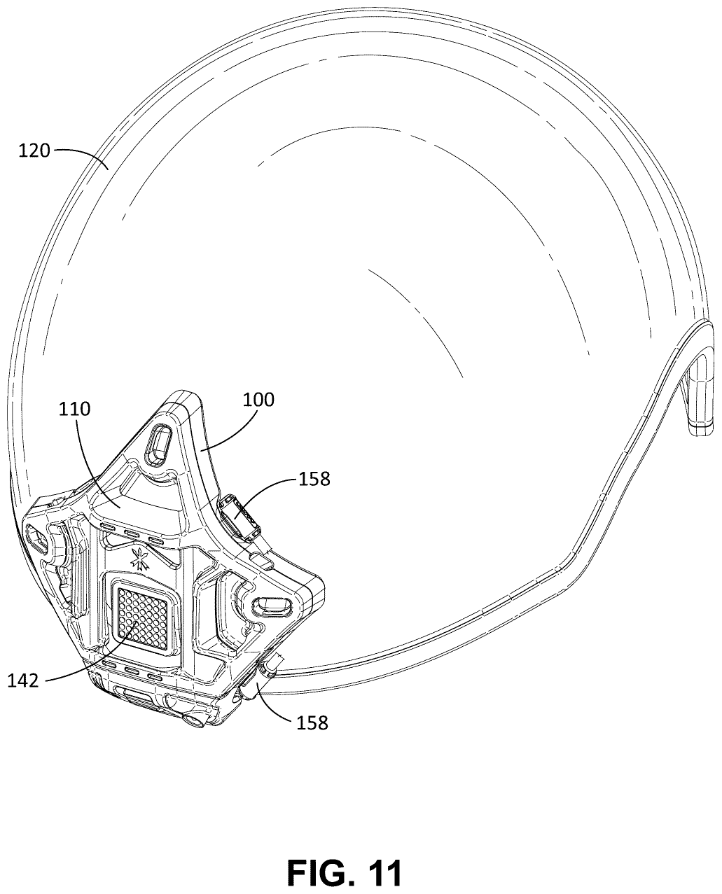

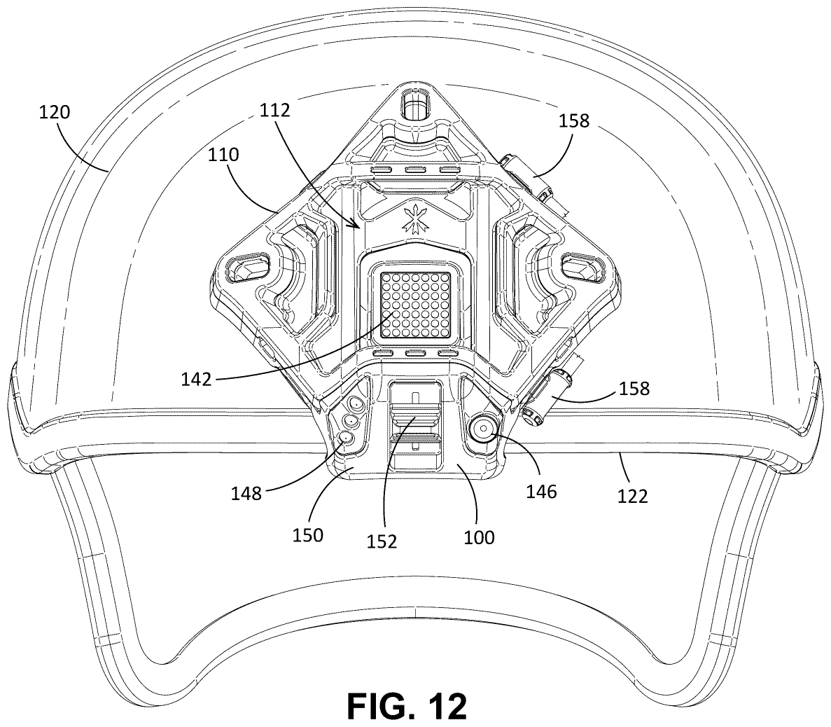

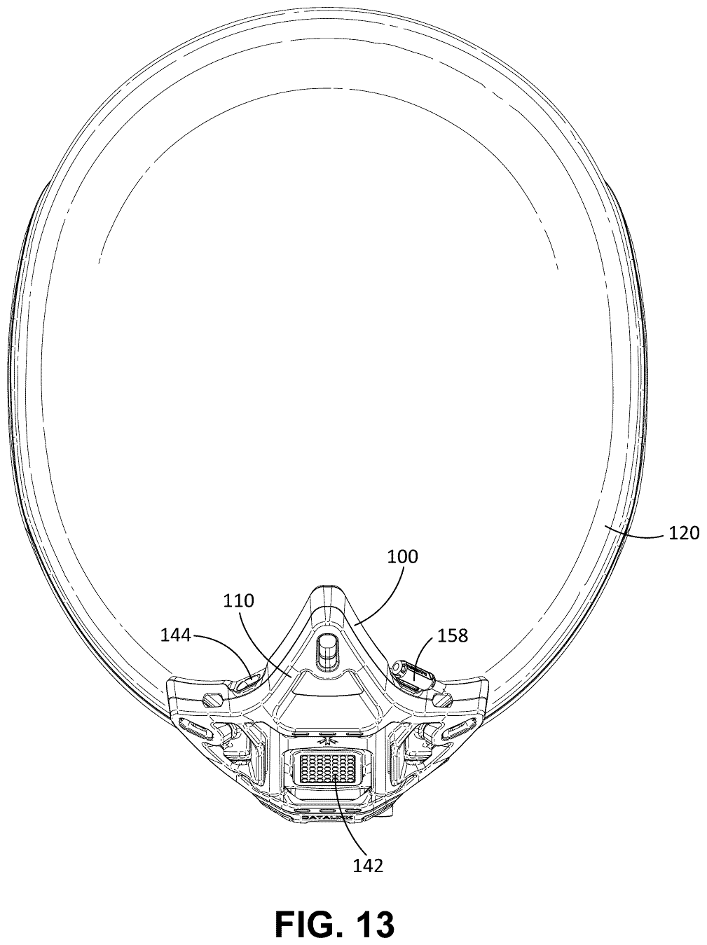

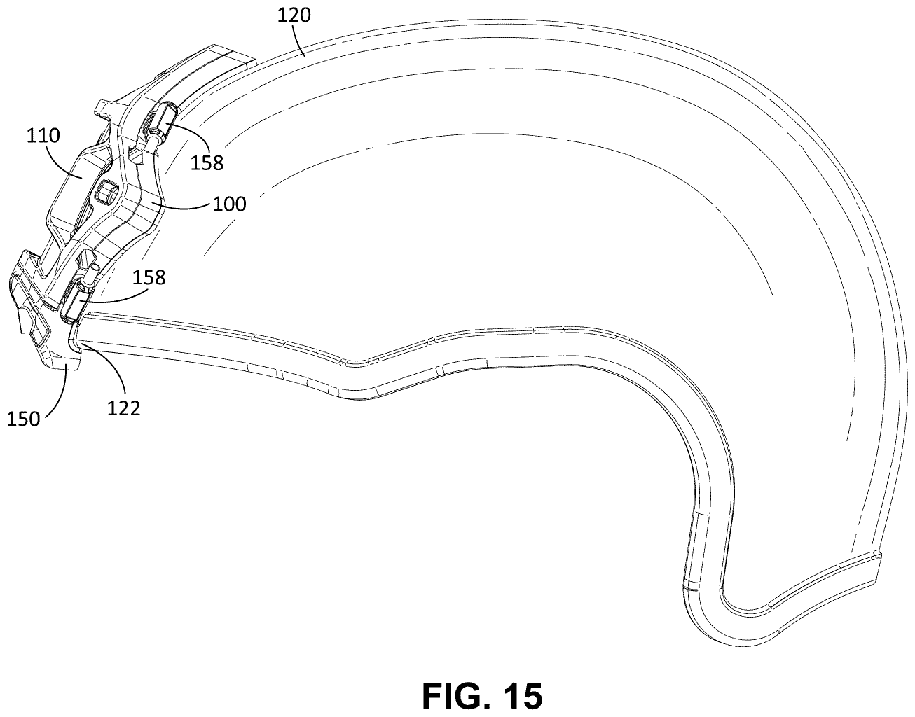

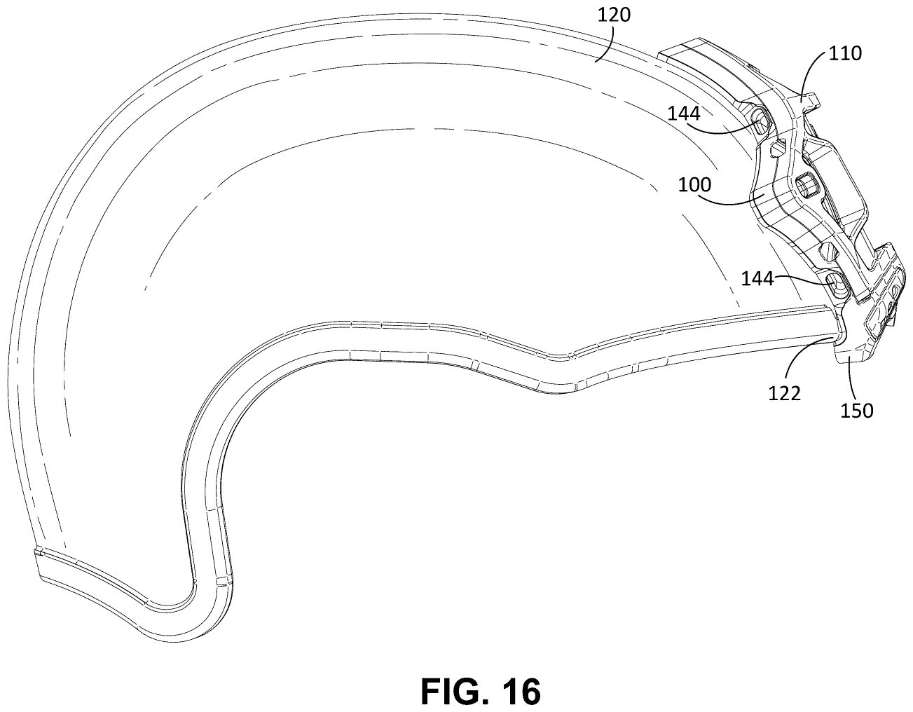

FIGS. 1-8 illustrate a power distribution hub 100 according to the principles of the present disclosure. FIGS. 9 and 10 illustrate a shroud 110 overlaying the power distribution hub 100. FIGS. 11-16 illustrate the power distribution hub 100 positioned between a helmet 120 and the shroud 110.

The power distribution hub 100 is configured to power one or more connected peripheral electronic devices, such as night-vision goggles, thermal imaging devices, augmented reality head-up displays, other visual augmentation devices, cameras, and illumination systems. In some implementations, the power distribution hub 100 may be configured to exchange data with one or more connected peripheral electronic devices in addition to supplying power.

The polymer housing 130 of the power distribution hub 100 includes a concave back surface 132 shaped to match the contour of the selected helmet 120, and a convex mating interface 134 shaped to match the contour of the selected shroud 110. Additionally, in some implementations, the mating interface 134 includes an opening 136 at each of its three corners. The three openings 136 are arranged so the power distribution hub 100 can be attached to a helmet 120 having a three-hole pattern, such as the standard MARSOC/WARCOM three-hole pattern. Each opening 136 is a slot configured to receive a fastener used to secure the power distribution hub 100 and shroud 110 to the selected helmet 120. In some implementations, the shroud 110 may be secured to the mating interface 134 using an adhesive or another suitable attachment method. The bottom edge of the mating interface 134 is bordered by a projecting ledge 138 that abuts the bottom edge of the shroud 110 (see, e.g., FIG. 9).

The power distribution hub 100 may be flexible, allowing it to conform to the exterior surface of the selected helmet 120 to which it is coupled. While the example housing 130 of the power distribution hub 100 is made of a polymer material such as polyphthalamide, in some implementations, the housing 130 may be made of another suitably durable, lightweight, and impact-resistant material or combination of materials, such as aluminum, carbon fiber, fiberglass, or another polymer. The housing 130 may be manufactured using injection molding, additive manufacturing, machining, or any suitable combination of these techniques.

The shroud 110 overlaying the power distribution hub 100 in FIGS. 9 and 10 is disclosed in U.S. patent application Ser. No. 18/524,288, entitled “HELMET SHROUD ASSEMBLY,” which is expressly incorporated herein by reference. The shroud 110 includes an interface 112 for the removable attachment of an accessory mount used to couple a night vision device, or other visual augmentation device, to the helmet 120. It should be noted that the mating interface 134, and the power distribution hub 100 as a whole, may be configured for use with other shrouds.

The power distribution hub 100 includes an onboard power source 140, a conductive interface 142, one or more USB ports 144, a camera system 146, a lighting system 148, a visual status system 150, and a power control switch 152. In other implementations, the power distribution hub 100 may include, in addition to the onboard power source 140, any combination of these native devices and/or other powered devices not explicitly listed herein.

The onboard power source 140 comprises one or more batteries contained within the polymer housing 130 of the power distribution hub 100. The one or more batteries are rechargeable, although in some implementations they may be disposable. Example battery types include, cylindrical cells (e.g., 18350 cells) and pouch cells. In some implementations, the onboard power source 140 may be housed in a receptacle 143 within the polymer housing 130. The onboard power source 140 is electrically connected to, and configured to supply power to, the native devices of the power distribution hub 100, as well as to peripheral electronic devices electrically connected to the power distribution hub 100.

The conductive interface 142 of the power distribution hub 100 is located on the mating interface 134 of the polymer housing 130. The conductive interface 142 comprises a plurality of electrical contacts 154 arranged in an array and positioned to be accessible through the interface 112 of the shroud 110. This configuration allows a suitably configured accessory mount, which includes a compatible conductive interface and is used to couple a peripheral electronic device to the shroud 110, to make conductive contact with the conductive interface 142. In some implementations, the plurality of electrical contacts 154 comprise a plurality of contact pins, each extending through a corresponding opening 155 in the mating interface 134. The conductive interface 142 is electrically connected to the onboard power source 140.

One or more USB ports 144 are positioned along the peripheral edge 156 of the polymer housing 130. The example implementation includes four USB ports 144, but other implementations may include fewer or more USB ports 144. In some implementations, each USB port 144 of the power distribution hub 100 is a USB-C port accessible through an opening in the peripheral edge 156 of the polymer housing 130. Each USB port 144 is electrically connected to the onboard power source 140. In this way, a compatible USB plug 158 can be used to connect a remote power supply, such as a battery pack, to the power distribution hub 100. The connected power source can be used to charge the onboard power source 140, power the native devices of the power distribution hub 100, power any peripheral electronic devices connected to the power distribution hub 100, or any combination thereof. While the example power distribution hub 100 includes USB-C ports 144, other implementations may include USB-A or USB-B ports, and still other implementations may include data and/or power interface ports that comply with any known or to-be-developed standard. In some implementations, the power distribution hub 100 may not include any USB ports 144.

The camera system 146 of the power distribution hub 100 includes at least one forward-facing camera. However, in some implementations, the camera system 146 may also include at least one side-facing camera and at least one upward-facing camera. The at least one camera of the camera system 146 is configured for recording video and/or still images. In some implementations, the camera system 146 also includes at least one audio recording device (not shown). The camera system 146 is electrically connected to the onboard power source 140. In some implementations, the power distribution hub 100 may not include a camera system 146.

The lighting system 148 of the power distribution hub 100 includes one or more lights 160. The lighting system 148 is positioned adjacent to the power control switch 152 and below the mating interface 134 of the polymer housing 130. The example lighting system 148 includes three lights 160. The polymer housing 130 is configured to house these three lights 160 and to direct light emitted from each light 160 in a direction generally away from the power distribution hub 100. Each of the three lights 160 is an LED. The LEDs 160 of the lighting system 148 may be configured to each emit the same or different colors of light. The example lighting system 148 includes one LED 160 configured to emit white light, one LED 160 configured to emit red light, and one LED 160 configured to emit infrared (IR) light. The lighting system 148 is electrically connected to the onboard power source 140.

The example power distribution hub 100 includes one lighting system 148 that provides three lights 160. However, in some implementations, the power distribution hub 100 may include one or more additional lighting systems 148, each configured to provide more or fewer lights 160. In some implementations, the power distribution hub 100 may not include a lighting system 148.

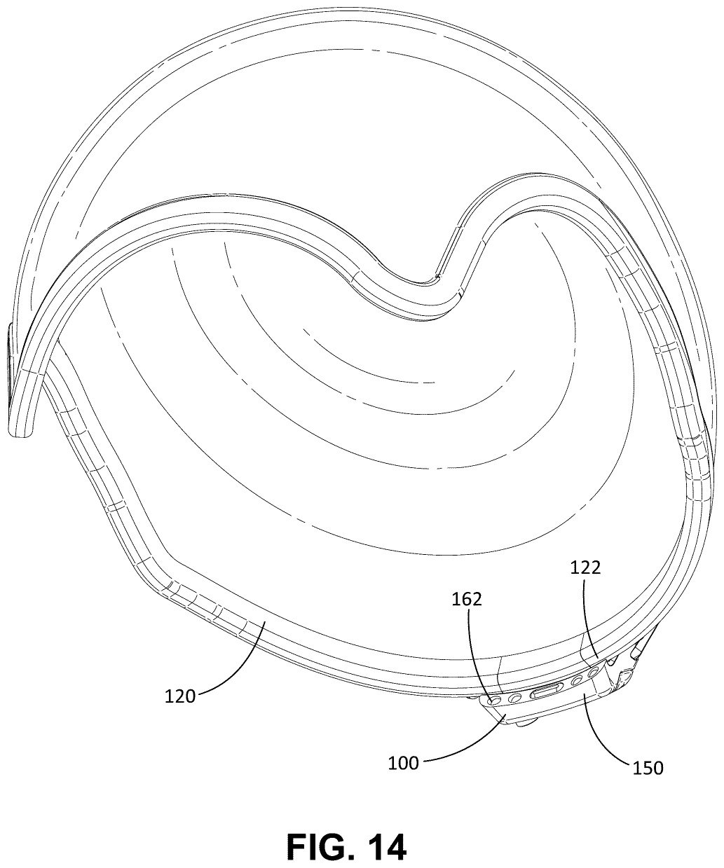

The visual status system 150 of the power distribution hub 100 includes one or more lights 162 that are visible to a user wearing a helmet 120 equipped with the power distribution hub 100. The portion of the polymer housing 130 that includes the visual status system 150 may be positioned below the concave back surface 132 of the polymer housing 130 and extend downward past the front lip 122 of the helmet 120 to which the polymer housing 130 is attached (see, e.g., FIG. 14). The example visual status system 150 includes four lights 162. The polymer housing 130 is configured to house these four lights 162 and direct light emitted from each light 162 toward the user. Each of the lights 162 is an LED. The LEDs 162 of the visual status system 150 may be configured to emit the same or different colors of light. As an example, one LED 162 may illuminate to indicate the status (e.g., on/off) of the power distribution hub 100, one LED 162 may illuminate to indicate the status (e.g., low power/fully charged) of the onboard power supply, one LED may illuminate when the camera system 146 detects a drone, and one LED may illuminate when incoming infrared is detected by the camera system 146. These are non-limiting examples; the lights 162 of the visual status system 150 may be configured to illuminate in order to communicate other information to the user. Additionally, a visual status system 150 with fewer or more than four lights 162 may be used without departing from the scope of the present invention. The visual status system 150 is electrically connected to the onboard power source 140. In some implementations, the power distribution hub 100 may not include a visual status system 150.

The power control switch 152 of the power distribution hub 100 is configured to control the routing of power from the onboard power source 140 and/or a remote power supply to the native devices of the power distribution hub 100 and to any connected peripheral electronic devices. The power control switch 152 is positioned between the lighting system 148 and the camera, and below the mating interface 134 of the polymer housing 130. The example power control switch 152 is a three-position manual toggle switch, which may be configured such that: a first position routes power from the onboard power source 140 to the native devices of the power distribution hub 100 and connected peripheral electronic devices; a second position routes power from a connected remote power supply to the native devices of the power distribution hub 100 and connected peripheral electronic devices; and a third position diverts power to a peripheral electronic device connected to the conductive interface 142 of the power distribution hub 100. These are non-limiting examples, and the power control switch 152 may be configured to route power differently. Additionally, a toggle switch 152 with fewer or more than three positions may be used without departing from the scope of the present invention. In some implementations, the power distribution hub 100 may not include a power control switch 152.

The power distribution hub 100 may include at least one processor and a nonvolatile memory. The at least one processor and nonvolatile memory may be positioned in the polymer housing 130, preferably near the onboard power source 140. The power distribution hub 100 may also include device-specific circuits providing additional hardware that enables the power distribution hub 100 to perform the specific functions disclosed herein and/or other desired functions. The at least one processor, nonvolatile memory, any device-specific circuits, or a combination thereof, may be mounted on a printed circuit board (PCB). The at least one processor is powered by the onboard power source 140 but can also be powered by an electrically connected remote power supply. One of the USB ports 144, using a suitably configured cable, can connect a computing device, such as a personal computer, to the at least one processor and nonvolatile memory. In this way, changes can be made to the function of the at least one processor, any program stored in the nonvolatile memory can be updated or removed, and any images, videos, or audio stored in the nonvolatile memory can be retrieved.

Although not shown in the drawings, it should be understood that suitable wiring and/or conductive traces may be provided within the polymer housing 130 to electrically connect various components of the power distribution hub 100, including, for example, the onboard power source 140, conductive interface 142, one or more USB ports 144, camera system 146, lighting system 148, visual status system 150, power control switch 152, and any onboard processor or memory.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment,” “implementation,” or words of similar import indicates that a particular described feature, structure, or characteristic is included in at least one embodiment of the present disclosure. Thus, the phrase “in some implementations,” or a phrase of similar import, as used throughout this specification, does not necessarily refer to the same embodiment.

The described features, structures, or characteristics may be combined in any suitable manner in one or more embodiments. In the above description, numerous specific details are provided for a thorough understanding of embodiments of the present disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

1. A power distribution hub comprising:
a housing including a concave back surface configured for attachment to a helmet and a mating interface configured for attachment of a shroud;
an onboard power source contained within the housing; and
a conductive interface disposed on the mating interface, electrically connected to the onboard power source, and configured to supply power to a connected peripheral electronic device.

2. The power distribution hub of claim 1, wherein the conductive interface comprises an array of electrical contacts.

3. The power distribution hub of claim 2, wherein each electrical contact extends through a corresponding opening in the mating interface of the housing.

4. The power distribution hub of claim 2, wherein the array of electrical contacts is configured to electrically connect with corresponding contacts on an accessory mount attached to the shroud.

5. The power distribution hub of claim 1, further comprising at least one USB port disposed along a peripheral edge of the housing, which is electrically connected to the onboard power source.

6. The power distribution hub of claim 5, further comprising a power control switch electrically coupled to the onboard power source and configured to selectively route power between the onboard power source, the conductive interface, and the at least one USB port.

7. The power distribution hub of claim 1, further comprising a camera system mounted within the housing and electrically connected to the onboard power source.

8. The power distribution hub of claim 1, further comprising a lighting system including at least one LED mounted within the housing and electrically connected to the onboard power source.

9. The power distribution hub of claim 1, further comprising a visual status system including at least one LED mounted on a portion of the housing positioned to be visible to a wearer of the helmet.

10. The power distribution hub of claim 1, wherein the mating interface includes an opening at each of its three corners.

11. A power distribution hub comprising:
a housing including a concave back surface configured for attachment to a helmet and a convex mating interface configured for attachment of a shroud;
an onboard power source contained within the housing; and
a conductive interface disposed on the mating interface, electrically connected to the onboard power source, and configured to supply power to a peripheral electronic device attached to the shroud.

12. The power distribution hub of claim 11, wherein the conductive interface comprises an array of electrically conductive pins.

13. The power distribution hub of claim 12, wherein each electrically conductive pin extends through a corresponding opening in the mating interface of the housing.

14. The power distribution hub of claim 12, wherein the array of electrically conductive pins is configured to electrically connect with corresponding contacts on an accessory mount attached to the shroud.

15. The power distribution hub of claim 11, further comprising at least one USB port disposed along a peripheral edge of the housing, which is electrically connected to the onboard power source.

16. The power distribution hub of claim 15, further comprising a power control switch electrically coupled to the onboard power source and configured to selectively route power between the onboard power source, the conductive interface, and the at least one USB port.

17. The power distribution hub of claim 11, further comprising a camera system mounted within the housing and electrically connected to the onboard power source.

18. The power distribution hub of claim 11, further comprising a lighting system including at least one LED mounted within the housing and electrically connected to the onboard power source.

19. The power distribution hub of claim 11, further comprising a visual status system including at least one LED mounted on a portion of the housing positioned to be visible to a wearer of the helmet.

20. A power distribution hub comprising:
a housing including a receptacle for a power source, a concave back surface configured for attachment to a helmet, and a shroud mating interface;
wherein the shroud mating interface comprises a conductive interface that is in electrical communication with the receptacle and is configured to supply power to a connected peripheral electronic device.
